(19) United States
(12) Patent Application Publication
(10) Pub. No.: US 2014/0274496 A1
(43) Pub. Date: Sep. 18, 2014

(54) Multilayered Ball Bats

(71) Applicant: BRETT BROS. SPORTS INTERNATIONAL, INC., Spokane Valley, WA (US)

(72) Inventors: Joe M. Sample, Mead, WA (US); Happy Wu, Taipei (TW)

(21) Appl. No.: 13/838,404

(22) Filed: Mar. 15, 2013

(51) Int. Cl. A63B 59/06; B27M 3/22

(52) U.S. Cl. CPC A63B 59/06; B27M 3/22
USPC 473/564; 144/350

(57) ABSTRACT

In one instance, the disclosure is a multilayered ball bat comprising multiple sheets of wood or other material. The sheets of wood can be uniform in thickness and are bonded together with adhesive. The sheets can also be made of fiberglass-reinforced wood. The sheets run the length of the bat, from the end-cap to the knob. The sheets are planar and run parallel to each other. Each sheet has two terminal sides. When the sheets are bonded together, the terminal sides form the hitting surfaces of the ball bat. The ball bat can also have multiple layers of different varieties of wood, with a less dense wood making up the top and bottom layers of the ball bat and a denser wood making up the middle layer of the ball bat. By using multiple sheets of uniform thickness, the ball bat is more break-resistant with an acceptable weight for swinging.

### TECHNICAL FIELD

The present disclosure relates to ball bats.

### BACKGROUND

Bats of various shapes and sizes have been used for a number of different sports and other recreational activities, the most common of which in the United States are baseball and softball. Bats have been made from a diverse range of materials from woods to metals to foams, and composites of more than one material. However, sporting league regulations have curbed the use of certain materials and often require bats to be made of specific types of material in accordance with prescribed specifications.

For example, professional baseball leagues require players to hit with wooden bats. Typically, these wooden bats are made from either a solid piece of wood or a small number of wooden pieces bonded together and then manufactured into the shape of a bat. These wooden bats are more prone to breaking when the force of a baseball hits the bat than bats made of, for example, aluminum.

In an attempt to increase the resistance to breakage, bat manufactures began using harder woods, but harder woods can cause the bat to be heavier than a softer wood, which increases the difficulty of swinging the bat. To diminish weight, softer woods are used, but such softer woods are more prone to breakage. As such, a natural tension can exist between a bat that performs well and a bat that is resistant to breakage.

### SUMMARY OF THE DISCLOSURE

Addressing drawbacks of the prior art, the present disclosure provides multilayered ball bats comprising many sheets of wood or composite material that can be the same thickness and can be the same length as the length of the bat from the barrel to the handle. The composite material can be wood that has been reinforced with fiberglass. The sheets of wood or composite material can be as thin as 0.5 millimeters. The number of sheets can be as many as can possibly fit within the diameter of the bat. The sheets, when bonded, can be substantially parallel to each other and can have uniform thickness.

In one embodiment, the present disclosure provides a bat with sheets made entirely of one variety of wood. In another embodiment, the present disclosure provides a bat with some sheets made of wood and some sheets made of wood and fiberglass. The sheets of wood and the sheets made of wood and fiberglass can be substantially uniform in thickness and can be bonded together, with the sheets running the length of the bat from the handle to the barrel, other than the portions of the sheets that are cut away when forming the ball bat from a billet of wood. Or, some of the sheets can run the entire length of the bat while others may run only a portion of the length of the bat.

In another embodiment, the present disclosure provides a bat with sheets of substantially uniform thickness made of differing woods, such as maple, ash, and/or birch. Some sheets may extend only from the knob of the bat to the end of the barrel, while other sheets may extend only from the end-cap of the bat to where the handle portion and barrel portion meet.

In another embodiment, the present disclosure provides a bat with layers of differing densities, wherein each layer can consist of wooden or composite sheets of substantially uniform thickness. The layers of sheets can be denser near the center of a cross-section of the bat as viewed when the layers of the bat run horizontally. The layers of sheets can be less dense near the top and bottom of a cross-section of the bat, as viewed when the layers of the bat run horizontally.

In these and other embodiments, the present disclosure will become more readily appreciated and understood from a consideration of the following detailed description of the exemplary embodiments of the present disclosure when taken together with the accompanying drawings.

### BRIEF DESCRIPTION OF THE DRAWINGS

FIG. 1 shows a side view of a multilayered ball bat.

FIG. 2 shows a cross-sectional view of a multilayered ball bat.

FIG. 3 shows a magnified cross-sectional view of a multilayered ball bat.

FIG. 4 shows a perspective view of one sheet of the ball bat depicted in FIG. 4.

FIGS. 5A-5B show a prospective view and cross-sectional view, respectively, of a finished multilayered ball bat.

FIG. 6 shows a sectional view of a multilayered ball bat as viewed from the end-cap of the bat.

FIG. 7 shows a perspective view of a multilayered ball bat as would be used in practice.

FIGS. 8A-8C show views of a multilayered ball bat from start of manufacturing to finished product.

### DETAILED DESCRIPTION

As can be seen in the embodiments shown in FIGS. 1-8, the multilayered ball bats may comprise multiple sheets of wood or other materials that are bonded together and lathed or otherwise cut into the shape of a ball bat.

FIG. 1 shows a side view and FIG. 2 shows a cross-sectional view of a multilayered ball bat 1, in accordance with embodiments of the present invention. The bat 1 has an elongated body comprising a handle portion 2 and a barrel portion 4. The handle portion 2 may comprise a handle 6 and a knob 8. The barrel portion 4 may comprise a barrel 10 and an end-cap 12. The handle 6 may have a smaller diameter than the barrel portion 4 in order to facilitate the gripping of the bat 1 by a batter. The knob 8 may have a larger diameter than the handle 6 so that the knob 8 acts to stop a batter's hands from slipping off the end of the ball bat 1 when swinging. The end-cap 12 is the terminal end of the barrel 10 of the ball bat 1. In some embodiments, the end-cap 12 may comprise a separate component that is affixed to the end of the barrel 10, but in other embodiments, the end-cap 12 is merely the distal end of materials forming the rest of the barrel 10 and is not a separate component.

Referring to FIG. 2, the ball bat 1 can be made of several sheets 14 of wood or other materials bonded together. In one embodiment, the sheets 14 can run the entire length of the ball bat 1 from end-cap 12 to knob 8 and can be substantially planar and parallel to each other. In another embodiment, the sheets 14 can run only a portion of the length of the ball bat. The sheets 14 can have a substantially uniform thickness, so that no one sheet 14 is purposefully made thicker than the other sheets 14. This uniform thickness can provide a stronger ball bat 1 throughout the entire barrel 10 of the bat 1, rather than having sheets 14 of differing thicknesses, which can cause weak points in the bat's break-resistance.

FIG. 3 shows a magnified cross-sectional view of a portion of a multilayered ball bat 1, in accordance with embodiments of the present invention. The ball bat 1 can include any number of sheets 14 from one to as many sheets 14 as can be bonded together to form the diameter of the bat 1. While any number of sheets 14 can be used, in one embodiment, the number of sheets 14 can be at least ten. The diameter of the ball bat 1 will vary depending on the sporting regulations and specifications allowed for any given sport and for any given league, and each bat 1 may have a varying diameter at different locations along the length of the bat 1, as illustrated in FIG. 1. One having ordinary skill in the art will be familiar with the regulations governing the diameter of a ball bat 1 for a given application. In one embodiment, the sheets 14 can be made exclusively of wood, in either a single variety or multiple varieties. In another embodiment, some of the sheets 14 can be made of wood while other sheets 14 can be made of a composition of wood and fiberglass, described hereafter as fiberglass-reinforced sheets 16.

Referring still to FIG. 3, the fiberglass-reinforced sheets 16 may be positioned between sheets 14 of wood, with the fiberglass-reinforced sheets 16 making up a portion of the sheets 14 while sheets of exclusively wood can make up the remaining sheets 14. The fiberglass-reinforced sheets 16 may run the entire length of the ball bat 1, from end-cap 12 to knob 8, or the fiberglass-reinforced sheets 16 may run only a portion of the length of the ball bat 1.

In one embodiment, referring to FIG. 4, each sheet 14 of the ball bat 1 can include a top side 18, a bottom side 20, an end-cap side 22, a knob side 24, and two terminal sides 26. The bottom side 20 of one sheet 14 is bonded to the top side 18 of an adjacent sheet 14, so that when all of the sheets 14 that make up the ball bat 1 are bonded together the end-cap side 22 of the sheets 14 when taken together make up the end-cap 12, all of the knob sides 24 make up the knob 8 when taken together, and the terminal sides 26 make up the hitting surfaces of the ball bat 1 when taken together.

In one embodiment, referring to FIGS. 5A-5B, the circumference of the barrel 10 of the ball bat 1 can be divided into four general quadrants: a first hitting surface 30a, a second hitting surface 30b opposite the first hitting surface 30a, a first non-hitting surface 28a, and a second non-hitting surface 28b opposite the first non-hitting surface 28a. In conventional solid wood bats, the hitting surfaces are located along the edge-grain face of the bat and the non-hitting surfaces are located on the flat-grain face of the bat. In accordance with the illustrated embodiment, when the ball bat 1 is oriented such that the sheets 14 are oriented horizontally, as shown in the cross-sectional view in FIG. 5B, the hitting surfaces 30a-30b are located along opposing lateral sides of the bat 1 and the non-hitting surfaces 28a-28b are located at the top and bottom of the bat 1. As a result, the hitting surfaces 30a-30b can make up the portion of the barrel 10 comprising the terminal ends 26 of the sheets 14. The non-hitting surfaces 28a-28b can make up the portion of the barrel 10 not comprising the terminal sides 26 of the sheets 14. The non-hitting surfaces 28a-28b can make up the portion of the barrel 10 wherein a logo or other information may be placed, which may not be meant for contacting a ball when the ball bat 1 is swung and can be used as a visual guide for the batter.

In one embodiment, referring to FIG. 6, the ball bat 1 can comprise three layers: a top layer 32, a bottom layer 34, and a middle layer 36. Each of the three layers can run the entire length of the ball bat 1, can be planar, and can be parallel and bonded to adjacent layers. Each layer can comprise one or more sheets 14 of uniform thickness. Each layer can also comprise one or more varieties of wood or other material. In one embodiment, the lop layer 32 and the bottom layer 34 can be comprised of a material that is less dense than the material that makes up the middle layer 36. A denser middle layer 36 may increase the ball bat's 1 resistance to breakage, while the less dense top layer 32 and bottom layer 34 may decrease the weight of the ball bat 1, making it easier to swing. In some embodiments, the top layer 32 and the bottom layer 34 can correspond to the non-hitting surfaces 28a-28b depicted in FIGS. 5A-5B, while the middle layer 36 can correspond with the hitting surfaces 30a-30b, also depicted in FIGS. 5A-5B.

In one embodiment, referring to FIG. 7, the ball bat 1 can be designed so that when it is swung by a batter and when the ball bat 1 contacts a ball, the ball contacts one of the two hitting surfaces 30a-30b, which can include the terminal sides 26 of the barrel 10. Also as depicted in FIG. 7, the ball bat 1 can be designed so that the non-hitting surfaces 28a-28b do not contact the ball when the ball bat 1 strikes the ball.

The ball bat 1 described herein can be formed in a variety of ways. For example, referring to FIGS. 8A-8C, multiple sheets 14 of varying thicknesses can be bonded together using glue or other adhesive. The sheets 14 are stacked one on top of the other, so that the top side 18 of one sheet 14 contacts the bottom side 20 of the next sheet 14. While the sheets 14 are being stacked, glue or other adhesive is applied to the top side 18 of one sheet 14 and then the next sheet 14 is stacked so that the bottom side 20 of that next sheet contacts the top side 18 of the first sheet. This process is repeated until all the sheets 14 are stacked together with glue or other adhesive between each sheet. Pressure can then be applied to the top side 18 of the top-most sheet 14 at the same time that pressure is applied to the bottom side 20 of the bottom-most sheet 14. The stack of sheets 14 can remain under pressure until the glue or other adhesive bonds the sheets 14 together and dries. The large number of sheets 14 may require drying times greater than typical when sheets of wood are bonded together.

Still referring to FIGS. 8A-8C, the sheets 14 can then be cut into billets with the square sides measuring at least the maximum diameter of the ball bat 1 to be formed from the billet, and the longest side measuring at least the length of the desired ball bat 1 from end-cap 12 to knob 8.

Again referring to FIGS. 8A-8C, the billet can then be lathed or otherwise cut to form the shape of a ball bat 1. The particular length, diameter, and overall size of the ball bat 1 will differ depending on application, such as whether the bat 1 will be made for softball or for baseball.

A lacquer, fiberglass coating, or other finish can then be applied to the ball bat 1. Additionally, a covering may be applied to the handle 6 such as a grip or tape. The end-cap 12 may be partially hollowed out to ensure proper weight distribution. A logo, label, or other writing can then be stamped, painted, pressed, or otherwise placed on the non-hitting surfaces 28a-28b, and writings describing weight and length can be stamped, painted, pressed or otherwise placed on the knob 8 of the ball bat 1.

As described above, the ball bat 1 can be made of a variety of materials. When made of wood, the sheets 14 forming the ball bat 1 can be made from a single variety of wood or from multiple varieties. In one embodiment, the ball bat 1 can be made of both wood and fiberglass-reinforced wood 16.

In use, the ball bat 1 can be swung as a batter would swing a wooden bat. The hitting surfaces 30a-30b are designed to make contact with a ball when the ball bat 1 is swung. A batter may place resin, chalk, or other substances on the ball bat 1 to help gain a better grip on the ball bat 1.

### EXEMPLARY EMBODIMENTS

The following paragraphs represent the many embodiments of the present disclosure but this section is not an exclusive description of all embodiments of the present disclosure.
1. A multilayered ball bat comprising an elongated body having a handle portion and a barrel portion, the elongated body comprising a plurality of substantially planar sheets of substantially equal thickness bonded together, the handle portion including a handle and a knob, and the barrel portion including a barrel and an end-cap.
2. The bat of paragraph 1, wherein the plurality of sheets comprises between 10 and 80 sheets.
3. The bat of any and all of paragraphs 1-2, wherein each sheet has a substantially uniform thickness of between about 0.5 and about 7.0 millimeters.
4. The bat of any and all of paragraphs 1-3, wherein the sheets are configured to be substantially parallel to each other.
5. The bat of any and all of paragraphs 1-4, wherein the sheets are configured so that each sheet longitudinally spans from the end-cap to the knob.
6. The bat of any and all of paragraphs 1-5, wherein the sheets comprise a single variety of wood.
7. The bat of any and all of paragraphs 1-6, wherein at least one sheet in the plurality of sheets is made from a composition of wood and fiberglass.
8. The bat of any and all of paragraphs 1-7, wherein the sheets made from a composition of wood and fiberglass make up at least 10% of the plurality of sheets.
9. The bat of any and all of paragraphs 1-8, wherein the sheets made from wood and the sheets made from a composition of wood and fiberglass are bonded to each other to form the plurality of sheets making up the elongated body.
10. The bat of any and all of paragraphs 1-9, wherein the barrel portion comprises a hitting surface and a non-hitting surface, each sheet in the plurality of sheets comprises a top side, a bottom side, a knob side, an end-cap side, and two terminal sides, the terminal sides extending the length of the elongated body, the hitting surface is configured to be the portion of the barrel that comprises the terminal sides of the sheets, and the non-hitting surface configured to be the portion of the barrel that does not contact a ball.
11. A multilayered ball bat comprising an elongated body having a handle portion and a barrel portion and comprising a plurality of substantially planar sheets of substantially uniform thickness, said elongated body comprising: a bottom layer comprising a first set of sheets from the plurality of substantially planar sheets, the first set of sheets having a first hardness, a top layer comprising a second set of sheets from the plurality of substantially planar sheets, the second set of sheets having a second hardness, and a middle layer positioned between the bottom and top layers, the middle layer comprising a third set of sheets from the plurality of substantially planar sheets, the third set of sheets having a third hardness wherein the third hardness is greater than the first hardness and second hardness.
12. The bat of paragraph 11, wherein the first set of sheets comprises at least two sheets, the second set of sheets comprises at least two sheets, and the third set of sheets comprises at least three sheets.
13. The bat of any and all of paragraphs 11-12, wherein the top layer is at least 22 millimeters thick at its thickest point, the middle layer is at least 31 millimeters thick at its thickest point, and the bottom layer is at least 22 millimeters thick at its thickest point.
14. The bat of any and all of paragraphs 11-13, wherein at the thickest portion of the elongated body the top layer comprises at least 29.5% of the elongated body, the bottom layer comprises at least 29.5% of the elongated body, and the middle layer comprises the remaining 41% of the elongated body.
15. The bat of any and all of paragraphs 11-14, wherein at least one sheet in the plurality of sheets is made from a composition of wood and fiberglass.
16. The bat of any and all of paragraphs 11-15, wherein at least one sheet in the top layer, at least one sheet in the bottom layer, and at least one sheet in the middle layer is made from a composition of wood and fiberglass.
17. A method of forming a ball bat having a bat length and a maximum bat diameter, comprising bonding a plurality of sheets to form a stack having a stack thickness, wherein a sheet thickness of each sheet in the plurality of sheets is substantially similar to the other sheets in the plurality of sheets, then cutting the stack into a plurality of billets, each of said billets having a thickness of at least the maximum bat diameter, a width of at least the maximum bat diameter, and a length of at least the bat length, and then lathing one of the plurality of billets to form a ball bat having a handle portion and a barrel portion.
18. The method of paragraph 17, wherein the plurality of sheets comprises a plurality of sheets of solid wood.
19. The method of any and all of paragraphs 17-18, wherein the plurality of sheets comprises a first plurality of sheets of solid wood and a second plurality of sheets of a wood composite.
20. The method of any and all of paragraphs 17-19, wherein the second plurality of sheets of wood composite comprise sheets of wood and fiberglass composite.
21. The method of any and all of paragraphs 17-20, wherein the second plurality of sheets of wood composite comprise at least 10% of the plurality of sheets forming the stack.
22. The method of any and all of paragraphs 17-21, wherein the bonding the plurality of sheets comprises bonding at least ten sheets.
23. The method of any and all of paragraphs 17-22, wherein each of the plurality of sheets has a substantially uniform thickness of between 0.5 and 7.0 mm.

The elements and limitations described in Paragraphs 1-23 can be combined with each other to create a multilayered ball bat.

While certain embodiments of the present disclosure have been disclosed in detail, it is to be understood that various modifications may be adopted without departing from the spirit of the disclosure.

Embodiments of the ball bats in accordance with the present disclosure can have greater impact strength than common wooden bats. Until now, utilizing a large number of planar wooden sheets with substantially uniform thickness has not been successfully employed. Older forms of layered bats were constrained to utilizing a small number of sheets, or sheets of non-uniform thickness, creating areas of differing break resistance on the bats and bats with less overall break resistance. Embodiments in accordance with the present disclosure may substantially increase the number of sheets of wood or other material that can make up a ball bat, and those sheets can have substantially similar thickness and be substantially planar and parallel to each other.

Embodiments of the ball bats in accordance with the present disclosure can significantly diminish flaking that may occur in wooden bats. In bats that do not employ a layered design, the rings of the wood that make up the bat make up a portion of the exterior of the bat, which contacts the ball. After repeated use, when the ball hits these rings, pieces of the bat hear the rings may flake off, leaving the hitting surface of the bat uneven and potentially unplayable. By utilizing the ball bat described herein, the hitting surface of the ball bat has few if any rings, significantly diminishing flaking and leading to a ball bat that can last longer.

Unless otherwise indicated, all numbers expressing quantities of ingredients used in the specification and claims are to be understood as being modified in all instances by the term “about.” Accordingly, unless indicated to the contrary, the numerical parameters set forth in the specification and attached claims and embodiments are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventors expect skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

What is claimed is:

1. A multilayered ball bat comprising:
an elongated body having a handle portion and a barrel portion;
the elongated body comprising a plurality of substantially planar sheets of substantially equal thickness bonded together;
the handle portion including a handle and a knob; and
the barrel portion including a barrel and an end-cap.

2. The bat of claim 1, wherein:
the plurality of sheets comprises between 10 and 80 sheets.

3. The bat of claim 1, wherein:
each sheet has a substantially uniform thickness of between about 0.5 and about 7.0 millimeters.

4. The bat of claim 1, wherein:
the sheets are configured to be substantially parallel to each other.

5. The bat of claim 1, wherein:
the sheets are configured so that each sheet longitudinally spans from the end-cap to the knob.

6. The bat of claim 1, wherein:
the sheets comprise a single variety of wood.

7. The bat of claim 1, wherein:
at least one sheet in the plurality of sheets is made from a composition of wood and fiberglass.

8. The bat of claim 7, wherein:
the sheets made from a composition of wood and fiberglass make up at least 10% of the plurality of sheets.

9. The bat of claim 7, wherein:
the sheets made from wood and the sheets made from a composition of wood and fiberglass are bonded to each other to form the plurality of sheets making up the elongated body.

10. The bat of claim 1, wherein:
the barrel portion comprises a hitting surface and a non-hitting surface;
each sheet in the plurality of sheets comprises a top side, a bottom side, a knob side, an end-cap side, and two terminal sides, the terminal sides extending the length of the elongated body;
the hitting surface configured to be the portion of the barrel that comprises the terminal sides of the sheets; and
the non-hitting surface configured to be the portion of the barrel that does not contact a ball.

11. A multilayered ball bat comprising:
an elongated body having a handle portion and a barrel portion and comprising a plurality of substantially planar sheets of substantially uniform thickness, said elongated body comprising:
a bottom layer comprising a first set of sheets from the plurality of substantially planar sheets, the first set of sheets having a first hardness;
a top layer comprising a second set of sheets from the plurality of substantially planar sheets, the second set of sheets having a second hardness; and
a middle layer positioned between the bottom and top layers, the middle layer comprising a third set of sheets from the plurality of substantially planar sheets, the third set of sheets having a third hardness;
wherein the third hardness is greater than the first hardness and second hardness.

12. The bat of claim 11, wherein:
the first set of sheets comprises at least two sheets, the second set of sheets comprises at least two sheets, and the third set of sheets comprises at least three sheets.

13. The bat of claim 11, wherein:
the top layer is at least 22 millimeters thick at its thickest point;
the middle layer is at least 31 millimeters thick at its thickest point; and
the bottom layer is at least 22 millimeters thick at its thickest point.

14. The bat of claim 11, wherein at the thickest portion of the elongated body:
the top layer comprises at least 29.5% of the elongated body;
the bottom layer comprises at least 29.5% of the elongated body; and
the middle layer comprises the remaining 41% of the elongated body.

15. The bat of claim 11, wherein:
at least one sheet in the plurality of sheets is made from a composition of wood and fiberglass.

16. The bat of claim 15, wherein:
at least one sheet in the top layer, at least one sheet in the bottom layer, and at least one sheet in the middle layer is made from a composition of wood and fiberglass.

17. A method of forming a ball bat having a bat length and a maximum bat diameter, comprising:
bonding a plurality of sheets to form a stack having a stack thickness, wherein a sheet thickness of each sheet in the plurality of sheets is substantially similar to the other sheets in the plurality of sheets;
cutting the stack into a plurality of billets, each of said billets having a thickness of at least the maximum bat diameter, a width of at least the maximum bat diameter, and a length of at least the bat length; and
lathing one of the plurality of billets to form a ball bat having a handle portion and a barrel portion.

18. The method of claim 17, wherein the plurality of sheets comprises a plurality of sheets of solid wood.

19. The method of claim 17, wherein the plurality of sheets comprises a first plurality of sheets of solid wood and a second plurality of sheets of a wood composite.

20. The method of claim 19, wherein the second plurality of sheets of wood composite comprise sheets of wood and fiberglass composite.

21. The method of claim 19, wherein the second plurality of sheets of wood composite comprise at least 10% of the plurality of sheets forming the stack.

22. The method of claim 17, wherein the bonding the plurality of sheets comprises bonding at least ten sheets.

23. The method of claim 17, wherein each of the plurality of sheets has a substantially uniform thickness of between 0.5 and 7.0 mm.
